(19) United States
(12) Patent Application Publication
(10) Pub. No.: US 2019/0197519 A1
(43) Pub. Date: Jun. 27, 2019

(54) Centralized Platform for Conducting Commercial Transactions Using a Near Field Communication Network

(71) Applicant: WORLDLINE, Bezons (FR)

(72) Inventors: Céline LY, LILLE (FR); Guillaume LEFEBVRE, MEURCHIN (FR); Colombe HERAULT, WALLERS (FR); Julien DECOSTER, AVELIN (FR)

(21) Appl. No.: 16/231,230

(22) Filed: Dec. 21, 2018

(30) Foreign Application Priority Data
Dec. 21, 2017 (FR) 1762738

(51) Int. Cl. G06Q 20/32; G06Q 30/06; G06Q 20/12; G06K 7/10; G06Q 30/02

(52) U.S. Cl. CPC G06Q 20/3278; G06Q 30/0633; G06Q 30/0201; G06K 7/10297; G06Q 20/12

(57) ABSTRACT

The invention concerns a system for conducting a transaction on a set of products available in a geographical area, including a plurality of RF scanners and a centralized platform, in which: each of said scanners is associated with a product and adapted, when scanning an RF badge, to transmit to said centralized platform a message containing at least one identifier of said product and an identifier associated with said badge; and said platform is associated with said geographical area and adapted to receive said messages and to store a virtual basket associating with the identifier of the badge the identifier or identifiers of products contained in the messages, and to display said virtual basket by means of a human-machine interface.

### CROSS-REFERENCE TO RELATED APPLICATION

The present application claims priority to French Application No. 1762738 filed with the French Patent Office on Dec. 21, 2017 and entitled “CENTRALIZED PLATFORM FOR CONDUCTING COMMERCIAL TRANSACTIONS USING A NEAR FIELD COMMUNICATION NETWORK,” which is incorporated herein by reference in its entirety for all purposes.

### FIELD OF THE INVENTION

The invention concerns the field of the conduct of commercial transactions consisting in selecting products on shelves before proceeding to payment for the selected products. The invention particularly applies to purchases in commercial areas such as supermarkets.

### CONTEXT OF THE INVENTION

Numerous solutions have been worked out to facilitate transactions, notably purchases, in commercial areas such as supermarkets.

A very widespread first solution consists in disposing labels on the products themselves. To effect the act of purchase, the customer goes to a dedicated terminal, or checkout, in order for the labels to be scanned. By determining the information contained in the labels, the terminal is able to generate a virtual basket for the customer containing all of the products the labels of which have been scanned. Once all the labels have been scanned, the customer can proceed to payment, generally by means of a payment (or point of sale (POS)) terminal associated with the terminal.

The labels are typically visual labels including a barcode, a QR code, or other optical systems enabling encoding of the information in a manner that a computer can read automatically.

However, other types of labels are equally possible, notably RFID (radio-frequency identification) type RF labels (or badges).

A solution of this kind has numerous disadvantages, however. Thus it necessitates placing the labels on each of the products on sale, which represents a cost because of on the one hand the cost of the label itself, notably in the case of an RF label, or badge, and on the other hand the labour necessary to stick the labels to each product.

Moreover, in the case of optical labels, the phase of the terminal scanning each label can be very long when the number of products to be purchased is large, and subject to errors. It notably necessitates manipulating the product to find the optical label and placed it in front of the scanner.

Another solution proposed recently consists in disposing near field communication badges (or labels) on the shelf locations for each type of product on sale. These badges can for example be NFC (near field communication) badges (or tags).

The customer has a near field communication (NFC) scanner that enables them to scan the content of the labels by placing it near them. This scanner may be in a dedicated mobile device or a mobile telecommunication terminal (smartphone, tablet computer, etc.).

The badges contain identifiers of the products so that by scanning all of the labels associated with the products to be purchased the mobile terminal is able to create the virtual basket consisting of all the products the identifiers of which have been scanned and which are therefore to be purchased. The customer is then able to proceed to payment, for example directly from their communication terminal using existing payment mechanisms, or at a checkout.

A solution of this kind therefore necessitates the use of a communication terminal equipped with an NFC scanner.

It further necessitates the customer to have their personal terminal in their hand at all times, which can generate risks of theft, dropping, or loss, or in any event a brake on the use of the solution. An alternative consists in making “mini scanners” available to customers, which generates a high additional cost for the store.

Another approach was proposed in U.S. Pat. No. 9,473,747, based on identifying and monitoring the customers of a store, notably by means of video images and face recognition techniques, and other sensors. An approach of this kind necessitates on one hand that the customers subscribe beforehand to this service (Amazon account, etc.) and on the other hand the deployment of a sizeable hardware and software infrastructure in the store (sensors, cameras, etc.).

### SUMMARY OF THE INVENTION

The object of the present invention is to provide a solution at least partly alleviating the aforementioned disadvantages.

To this end, the present invention proposes a method for conducting a transaction on a set of products available in a geographical area, including
a near field communication scanner scanning an RF badge, being one of a plurality of RF scanners, each of said scanners being associated with a product;
transmitting a message containing at least one identifier of said product and an identifier associated with said badge to a centralized platform associated with said geographical area,
storing a virtual basket associating with said identifier of said badge, said identifier or identifiers of products contained in said messages, and
displaying the virtual basket by means of a human-machine interface.

The method may further include a final step of payment for the products identified in said virtual basket.

The invention also consists in a system for conducting a transaction on a set of products available in a geographical area, including a plurality of RF scanners and a centralized platform, in which
each of said scanners is associated with a product and adapted, when scanning an RF badge, to transmit to said centralized platform a message containing at least one identifier of said product and an identifier associated with said badge;
and said platform is associated with said geographical area and adapted to receive said messages and to store a virtual basket associating with said identifier of said badge said identifier or identifiers of products contained in said messages, and to display said virtual basket by means of a human-machine interface.

According to preferred embodiments, the invention comprises one or more of the following features that may be employed separately or in partial or total combination with one another:
the system further includes a mobile telecommunication terminal implementing said human-machine interface and means adapted to effect payment for the products identified in said virtual basket;
the system further includes a terminal associated with said geographical area implementing said human-machine interface and an RF scanner for triggering the display of said virtual basket when scanning said badge;
the terminal includes a payment terminal adapted to effect the payment for the products identified in said virtual basket;
the messages are transmitted via a radiocommunication network;
said scanners and said badge conform to the near field communication (NFC) standards;
said message conforms to the MQTT protocol;
the platform is adapted to constitute statistics representing the behaviour of said customers on the basis of information obtained through said messages.

The invention therefore enables customers to save time through the provision of a simple, rapid and self-contained system (with no necessity for interaction with checkout staff). Moreover, it does not necessitate additional objects for the customer (card, badge, etc.) if they already have an NFC card or badge enabling them to be identified.

For the merchant, the invention enables total digitization of the customer's route, which makes it possible to minimize the costs of managing and to increase their knowledge of their customers. Nor does it necessitate the installation of costly or atypical equipment, only standard equipment.

Other features and advantages of the invention will become apparent on reading the following description of a preferred embodiment of the invention, given by way of example and with reference to the appended drawings.

### BRIEF DESCRIPTION OF THE DRAWINGS

FIG. 1 illustrates diagrammatically a high-level embodiment of the invention.

FIGS. 2a, 2b, 2c, 2d represent four concrete implementations of certain aspects of the invention.

### DETAILED DESCRIPTION OF THE INVENTION

The invention particularly applies to the context of a delimited geographical area such as a self-service point of sale. It can be an area the size of a supermarket or a minisupermarket or even a hypermarket.

In a commercial area of this kind products are typically disposed on shelves and classified by type. A label is disposed in front of each product sold displaying information on the product: designation, price, reference numbers, where applicable a price per kilo, etc.

According to the classic definition in this field, a product corresponds to each of the catalogue product codes or standard commercial offers marketed by an enterprise. As a result, a product can be a tangible product, but also a fixed charge, a provision of service, a subscription, an application, etc.

It should also be noted that according to this definition a customer purchases one or more examples of a product. For instance, they may purchase three “cookies” or one “bottle of water”, the “cookie” and “bottle of water” products being moreover particularized by type, price, brand, etc.

By an abuse of language simplifying the description, it will be understood that the expression “purchase of a product” must therefore be understood as equivalent to the purchase of one example of a product.

Moreover, the description is focused on the act of purchase but, in its generality, the invention can cover other types of transaction: hire, possibly borrowing in a library, etc.

According to the invention, there is further provided a plurality of RF scanners, each associated with a particular product (that is to say with a product code from the catalogue of the store).

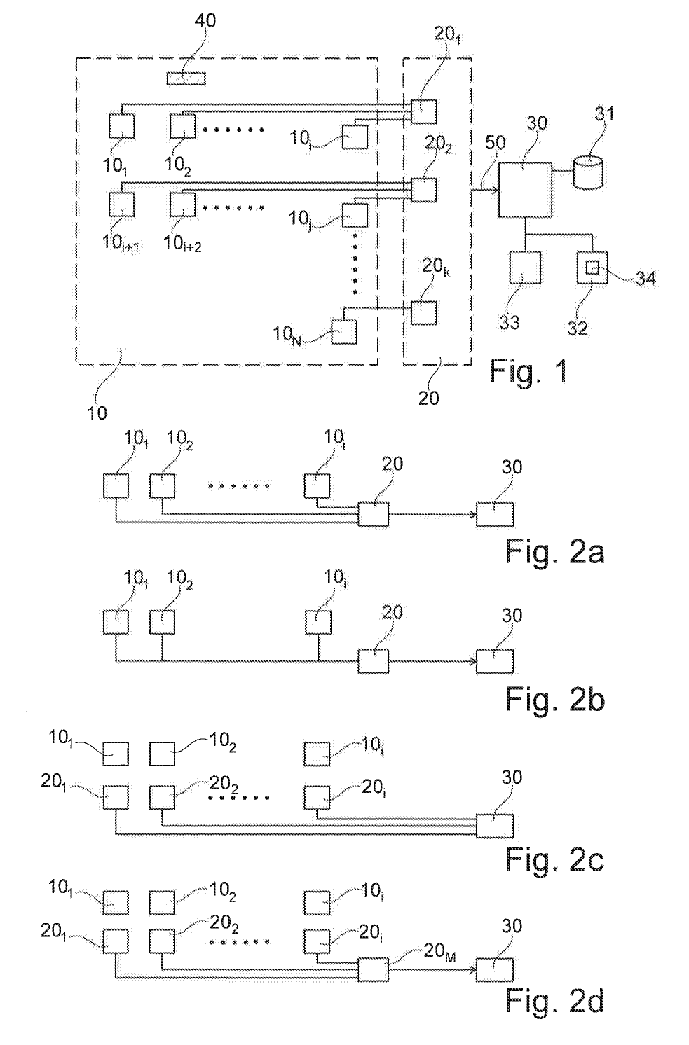

FIG. 1 illustrates diagrammatically a high-level embodiment of the invention.

The RF scanners 10₁, 10₂ . . . 10ᵢ, 10ᵢ₊₁, 10ᵢ₊₂ . . . 10ⱼ . . . 10_{N} are organized in groups that can correspond to departments of the commercial area. The invention can nevertheless be applied regardless of the number of groups, including a single group. As will emerge later, this group concept impacts only the hardware architectures enabling implementation of the invention, but has no impact on the highest functional level.

Each scanner can be associated with a product, beside which it is physically disposed. In concrete terms, it can be situated beside or behind a physical label associated with the product in order to be easily located and seen by customers.

The customer wishing to acquire (for example purchase) a product approaches an RF badge (or RF-label) 40 of the scanner corresponding to the product in question in order to enable communication between the scanner and the badge.

A near field communication type technology can typically be used, where the RF scanner is an NFC scanner or an antenna of an NFC scanner.

Near field communication (NFC), a short-range high-frequency wireless communication technology, enables the exchange of information between peripherals up to a distance of approximately 10 cm in the general case. This technology is an extension of the ISO/IEC 14443 standard that standardizes proximity cards utilizing RF-identification (RFID).

It is to be noted that although the NFC technology is known in its use for commercial transactions in a commercial area, the invention notably proposes to reverse the uses of the scanner and the badge. In fact, according to the invention, the customer has an NFC badge whereas the scanners are associated with the products, in contrast to the prior art.

The RF badge can be personal, that is to say attributed to and corresponding to a particular customer. It may for example be a credit card with this kind of RF-label (a contactless credit card), but equally a loyalty card or any other card or device given to its customers by the commercial area and enabling them to be identified. Other types of cards can be used, notably cards independent of the commercial area: public transport cards, library cards, etc., provide that they are able to identify a customer uniquely.

Such identification may be valid for the time of a session, that is to say for the time for which the customer is in the commercial area, so that at a given moment there may be only one customer corresponding to a given RF card identifier.

However, such identification can equally be valid over a longer time period (as for example with a credit card or a loyalty card, etc.), enabling the commercial area and the customer to establish an ongoing customer profile from one visit to another to the commercial area (or another commercial area of the same chain, in the case of a chain store).

When the badge 40 is sufficiently near an RF scanner (10₂ in the FIG. 1 example), the latter is able on the one hand to detect its presence and on the other hand to proceed to scan its content, receiving and analyzing the RF wave modified by the passive circuit of the badge, or RF-label.

According to the invention, this content contains an identifier associated with the badge. That identifier typically identifies the customer carrying the badge, but other arrangements are equally possible (collective identifier for a plurality of customers, etc.).

Means 20 are provided that, on scanning a badge, trigger the transmission of a message 50 intended for a centralized platform 30 that is associated with the commercial area.

Those means may include a plurality of modules. Those modules may implement distinct functions (message formatting, establishing/checking the connection between the scanners and the platform, etc.), and each of them can also be associated with groups of scanners.

In the example from FIG. 1, modules 20₁, 20₂ . . . 20ₖ are respectively associated with k groups of scanners, corresponding to k departments in the store, 10₁, 10₂ . . . 10ᵢ (for the module 20₁), 10ᵢ₊₁, 10ᵢ₊₂ . . . 10ⱼ (for the module 10₂), . . . 10_{N} (for the module 10ₖ).

Obviously other arrangements are possible in the context of the invention.

The means 20 may be adapted to effect a check on the NFC scanners and to process information received from those NFC scanners. For example, there may be provision for filtering out duplicate scans: in fact, the customer may manipulate their RF badge in such a way that it is scanned twice (or more times) by the scanner. A duplicate scan caused by mishandling must be discarded and only one message 50 transmitted to the centralized platform.

The means 20 may also distinguish this situation from that in which the customer actually wishes to validate the same product twice (for example if they wish to purchase two of the same product). The distinction between these two situations may be effected on the basis of a time delay between two scans of the same badge by the same scanner.

The means 20 may be adapted to transmit an acknowledgement to the customer when the scan has been effected correctly. That acknowledgement may be visual and/or audible, at the level of the label.

If the badge presented is not compatible or cannot be scanned for any reason, the absence of an acknowledgement enables the customer to realize that their purchase (or hire, etc.) has not been validated and to react. It is equally possible to transmit a visual and/or audio signal different from that of an acknowledgement.

The means 20 are also adapted to format a message 50 suitable for transmission to the centralized platform 30. They therefore enable interfacing with the communication network enabling the connection with that platform, and equally the construction of the message from the information scanned by the NFC scanners, and possibly information determined locally, depending on the protocol in force.

The message 50 can be transmitted to the centralized platform 30 by various means. A cable (Ethernet, etc.) network can be set up, likewise a wireless (WiFi, etc.) network. The choice of a technology may notably be dictated by the size and the layout of the commercial area. The means 20 are then adapted to establish and maintain a network connection between them and the centralized platform.

According to one embodiment of the invention, the message 50 can be transmitted in accordance with the MQTT (MQ Telemetry Transport) protocol. That protocol is beneficial because it is optimized to minimize the size of messages and exchanges. It is moreover bidirectional and simple to implement.

However, other protocols are equally possible for implementing the method and transmitting the message 50: HTTP, HTTPS, IP or web sockets, etc.

This message 50 contains at least one identifier of the badge 40, which has been scanned by a scanner 10₁ . . . 10_{N}, and an identifier of the scanner that effected that scan. In other words, the message contains an association between two identifiers that represent a scanner/badge pair formed by establishing temporary communication when a customer presents their badge to the scanner associated with a desired product.

According to one embodiment of the invention, the message 50 can also transmit a time and date.

According to one embodiment of the invention, the message 50 can also contain an identifier of the store. It is then possible to manage a plurality of stores via the same centralized platform.

The message 50 is then received by the centralized platform 30.

By “centralized” is meant here that it functionally covers all of the geographical area that the mechanism set up in accordance with the invention concerns. It can notably cover all of a minisupermarket, a supermarket, a hypermarket, etc., so that a customer is processed by the same platform throughout their time in the area.

According to one embodiment, the platform can even cover a plurality of physically separate stores (and therefore stores at different geographical locations).

However, the implementation need not be “centralized”, but to the contrary be distributed across a set of servers, notably for issues of load distribution and/or redundancy.

Equally, this platform can be implemented so as to manage a set of commercial areas, for example in the case of chain stores, so that the same customer can be recognized in all the stores.

The centralized platform 30 is then able to store a virtual basket containing this association between identifiers of a product (that is to say of an RF scanner) and a customer (that is to say an RF badge).

In the example shown, this virtual basket is stored in a database 31, but other implementations are possible. In particular, it may be stored in a cloud platform.

As the customer moves around in the area, new messages 50 will be transmitted from RF scanners of other products but associated with the same customer. The virtual basket is then updated so that the same badge or customer identifier is associated with a plurality of product identifiers or RF scanners.

The platform 30 also enables this virtual basket to be displayed to the customer, by means of a human-machine interface.

That human-machine interface can be implemented by a mobile telecommunication terminal 33. Using their own telecommunication terminal (mobile telephone, smartphone, tablet computer, connected object, etc.) to view their virtual basket, notably in order to verify its content and possibly, where appropriate, to modify it (remove a product, modify a quantity or a number of examples of a product, etc.).

This human-machine interface may also be implemented by the terminal 32 associated with the geographical area (minisupermarket, supermarket, hypermarket, etc.). This terminal, or checkout, has a screen on which the basket can be displayed, after the customer has identified themselves to the terminal. The identification may be effected by any means, including by means of their RF badge, which they present to an RF scanner associated with the terminal.

These two interfaces may be complementary: within the same area, customers may choose between access to their virtual basket via a terminal 32 or via their mobile telecommunication terminal 33.

In the context of a commercial transaction, this may give rise to a financial transaction (purchase, hire, etc.), which may equally be manifested via this human-machine interface.

The financial transaction, and in particular the payment for the products identified in the virtual basket, can also be implemented via the mobile telecommunication terminal 33 and/or a terminal 32.

According to a first embodiment, the payment may be effected by the customer via the mobile communication terminal 33, after they have viewed the virtual basket. The customer is able to effect all the operations of viewing the basket (to validate the content thereof) and payment with their mobile communication terminal, without using a store's terminal, or even a payment (point of sale (POS)) terminal.

According to a second embodiment, the customer views their virtual basket on a terminal 32 and uses their mobile communication terminal as payment means.

In these two embodiments, different mechanisms have been proposed and are therefore available to enable payment by mobile telephone. There may in particular be mentioned the “mobile wallet” service or the “merchant wallet” of Wordline, or “Google Wallet”.

The payment can be made by entering a PIN secret code, but other mechanisms can equally be envisaged (bank transfer, etc.).

According to a third embodiment, the terminal 32 includes a payment terminal 34 adapted to effect the payment for the products identifier in the virtual basket. The customer is able to view the content of the virtual basket via the human-machine interface used by the terminal in order to validate it, as in the previous embodiment, and then to proceed to payment via the payment terminal 34 integrated into the terminal, using for example a credit card, a prepaid card or cash.

Other types of transactions and other uses of the principles of the invention are equally possible.

By way of example, there may be mentioned a subscription mechanism: the customer subscribes to certain products of the area (for example, a meal formula including a sandwich and a drink). According to this subscription, the customer is debited whether they take the products or not.

On entering the store, it is therefore a question of verifying that they conform to their subscription.

In this application example, the store could equip with RF scanners only the products that can be included in the subscription formulas.

Other mechanisms are possible, such as another form of subscription where the customer authorizes a maximum debit per period (month, etc.) or per passage through the checkout, and/or a maximum number of passages through the checkout. As long as these limits are not reached, the customer does not need to validate or to confirm their purchases with any terminal, following validation of the products in store via NFC scanning.

Another example is to enable the provision of a proof of purchase: having finalized the purchase of the products, the customer receives a proof of purchase, for example in the form of a QR code, which may be digital or in printed form. This proof of purchase can then be used to show to a security guard or scanned with a scanner (for automatic door opening, etc.).

FIGS. 2a, 2b, 2c, 2d represent four concrete implementations of certain aspects of the invention.

In FIG. 2a, the RF scanners 10₁, 10₂ . . . 10ᵢ are in the form of near field communication (NFC) scanners. They are connected to an information processing device 20, which may for example be a “Raspberry Pi” type nanocomputer or the like.

The device 20 is able to power the NFC scanners and to communicate with them via a cable network. It also has an interface enabling it to communicate with the centralized platform 30, either via a cable communication network or via a wireless, WiFi or other communication network.

In FIG. 2b the RF scanners 10₁, 10₂ . . . 10ᵢ are antennas of the same NFC scanner, which can be incorporated in the means 20. Those means 20 may further comprise an interface to the centralized platform 30. This solution has the advantage of multiplying only the antenna by the number i of products on offer. The circuits of the NFC scanner are pooled for all of them.

According to one embodiment, it is possible to use a multi-antenna NFC scanner.

According to another embodiment, the NFC scanner is a single-antenna scanner and there is disposed between this scanner and the antennas an antenna switch controlled by a signal from proximity sensors disposed facing the labels. Accordingly, when the customer places the product in front of the label, the corresponding proximity sensor controls the antenna switch in order for the NFC scanner to read the RF signal on the corresponding antenna.

This second embodiment has the advantage of necessitating only standard devices (single-antenna NFC scanner). Moreover, it enables energy consumption to be limited since the antennas can be powered only at the time of scanning (by switching), and the consumption of an antenna is much greater than that of a proximity sensor.

Finally, it makes it possible to prevent a badge from being scanned by a scanner very close to the scanner targeted by the customer: in fact, in this embodiment, a single antenna is activated, that nearest the product presented by the customer, which prevents these edge effects.

In the FIG. 2c example, the RF scanners are near field communication (NFC) scanners. Each of them is connected to a respective module 20₁, 20₂ . . . 20ᵢ of the means 20. Each of those modules is autonomous and able to communicate with the centralized platform 30 via a cable or wireless communication network.

In the FIG. 2d example, the RF scanners are near field communication (NFC) scanners. As before, each of them is connected to a respective module 20₁, 20₂ . . . 20ᵢ of the means 20. Those modules are adapted to control the NFC scanners. They are connected to a “master” module 20_{M} that provides the interface with the centralized platform 30. Compared to the FIG. 2a embodiment, the communication between the NFC scanners and the module 20/20ₘ is greatly facilitated by the presence of the “local” modules 20₁, 20₂ . . . 20ᵢ: in fact, in the FIG. 2a solution five or six control wires are necessary, whereas a single wire can be deployed in the FIG. 2d solution, which obviously facilitates deployment and maintenance in a commercial area.

One of the advantages of the invention is that all of the process of purchase (or hire, borrowing, etc.) by the customer is managed by the centralized platform. This therefore enables acquisition of information on the one hand on the customer themselves, but also on their behaviour in the geographical area.

Accordingly, it enables customer profiles to be created, which enables improvement of the commercial relations between the management of the area and their customers (loyalty operations, etc.).

It also enables creation of statistics on the behaviour of customers, based on information obtained via the messages received: mean time between the first selection of a product and payment, etc.

It also enables real time synchronization of all customers, of all virtual baskets for all terminals (store terminals or customers' mobile terminals).

Moreover, it enables customers to be able to put together their virtual basket in a very simple and ergonomic manner. They can use a single card, issued by the commercial area, that includes a single identifier. That card not needing to have any particular value, its use is not impeded by any psychological brake.

Another advantage of the invention is that, in some embodiments, it can be deployed using the same scanner infrastructure to add a product to the virtual basket and to consult that basket at a terminal. Likewise, in the case of door control or opening, that same infrastructure can again be used.

Of course, the present invention is not limited to the examples and to the embodiment described and shown, but is open to numerous variants accessible to the person skilled in the art.

1. Method for conducting a transaction on a set of products available in a geographical area, including:
a near field communication scanner scanning an RF badge, being one of a plurality of RF scanners, each of said scanners being associated with a product, in order to determine an identifier contained in said badge and identifying a customer associated with said badge over a duration greater than said transaction;
said communication scanner transmitting a message containing at least one identifier of said product and said identifier to a centralized platform associated with said geographical area,
storing a virtual basket associating with said identifier or identifiers of products contained in said messages, and
displaying the virtual basket by means of a human-machine interface.

2. Method according to claim 1, including a final step of payment for the products identified in said virtual basket.

3. System for conducting a transaction on a set of products available in a geographical area, including a plurality of RF scanners and a centralized platform, in which:
each of said scanners is associated with a product and adapted, when scanning an RF badge to transmit to said centralized platform a message containing at least one identifier of said product and an identifier contained in said badge and identifying a customer associated with said badge over a duration greater than said transaction;
and said platform is associated with said geographical area and adapted to receive said messages and to store a virtual basket associating with said identifier of said badge said identifier or identifiers of products contained in said messages, and to display said virtual basket by means of a human-machine interface.

4. System according to claim 3, further including a mobile telecommunication terminal implementing said human-machine interface and means adapted to effect payment for the products identified in said virtual basket.

5. System according to claim 3, further including a terminal associated with said geographical area implementing said human-machine interface and an RF scanner for triggering the display of said virtual basket when scanning said badge.

6. System according to claim 5, in which said terminal includes a payment terminal adapted to effect the payment for the products identified in said virtual basket.

7. System according to claim 3, in which said messages are transmitted via a radio communication network.

8. System according to claim 3, in which said scanners and said badge conform to the near field communication (NFC) standards.

9. System according to claim 3, in which said messages conform to the MQTT protocol.

10. System according to claim 3, in which said platform is adapted to constitute statistics representing the behaviour of said customers on the basis of information obtained via said messages.
